(19) United States
(12) Patent Application Publication
(10) Pub. No.: US 2010/0263245 A1
(43) Pub. Date: Oct. 21, 2010

(54) Retractable Display Board

(76) Inventor: Michael John Bowser, Toronto (CA)

Correspondence Address: Michael Bowser, 4 Lockheed Blvd, Toronto, ON, M9P 2H6, CA

(21) Appl. No.: 12/426,221

(22) Filed: Apr. 17, 2009

(51) Int. Cl. G09F 11/21

(52) U.S. Cl. 40/517

(57) ABSTRACT

The present invention is a retractable display hoard having first and second elongated frame elements each having opposite ends for supporting the flexible display surface. The display surface of the board consists of an elongated flexible sheet having a width. Opposite first and second ends. The first and second frame elements each having a length sufficient to span the width of the sheet and the first end of the sheet is attached to the first frame. The board includes an elongated roller at inched to the second frame element and extending along the length of the second frame element. The second end of the flexible sheet being attached to the roller and the roller being dimensioned and configured to permit the second sheet to be furled onto the roller. The board also includes a lockable recoil mechanism coupled to the roller for permitting the roller to unfurl the sheet from the roller when the first and second frame elements are pulled apart from one another, the recoil mechanism being adapted and configured to hold the sheet in the unfurled position when the mechanism is locked, the recoil mechanism being further configured to automatically re-furl the sheet when the lock is released. Furthermore, the first and second frame elements being dimensioned and configured to house the roller and sheet when the sheet is fully furled onto the roller.

### BACKGROUND OF THE INVENTION

Display boards are a handy way to convey a message or information, draw out or illustrate concepts and ideas. Portable display boards have the advantage over their full sized counterparts in being transportable, conveniently allowing a user to take the board from place to place. Portable display boards have a significant drawback, namely that they must necessarily be smaller in order to be portable. Smaller boards while portable are less visible; making portable display hoards difficult to be viewed from a distance and ineffective in presenting information In a room full of people. A display board, which is portable, easy to transport and requires minimal storage space, while permitting a large surface would be an ideal tool for presenting information.

It is also known in the prior art to provide portable display and or presentation boards, examples of which can be seen in the following patents and applications.

### Canadian

Patent 987264 issued Apr. 13, 1976
Patent Application 2340834 filed Mar. 21 2001 by Bown
Patent Application 2350427 filed Jun. 14 2001 by Parshad.
Patent Application 2340834 filed Jun. 28 2004 by Manocheo/Ternovits

### United States of America Patents

5,131,448 issued July 1992 to Miller

5,388,382 issued February 1995 to Brooks

5,439,043 issued August 1998 to Carter

5,987,794 issued November 1999 to Lavi et al

6,523,288 issued Feb. 25, 2003 to Sacket

6,666,424 issued Dec. 23, 2003 to Richardson

6,941,691 issued September 2005 Arko et al

7,040,899 issued May 2006 Armstrong

### SUMMARY OF THE INVENTION

In accordance with one aspect of the present invention, there is provided a display board which overcomes the limitations of the prior art by providing an elongated flexible display board which rolls away when not in use. The display board includes first and second elongated frame elements each having opposite, ends for supporting the flexible display hoard. The surface of the hoard consists of an elongated flexible sheet having a width, opposite first and second ends and a surface proportioned to be easily viewed. The first and second frame elements each having a length sufficient to span the width of the sheet.

The board includes an elongated roller attached to the first frame element and extending along the length of the first frame element. The first end of the flexible sheet being attached to the roller and the roller being dimensioned and configured to permit the sheet to be furled onto the roller. The second end of the flexible sheet is attached to the second frame element. The board also includes a lockable recoil mechanism coupled to the roller for permitting the roller to unfurl the sheet front the roller when the first and second frame elements are pulled apart from one another, the recoil mechanism being adapted and configured to bold the sheet in the unfurled position when the mechanism is locked, the recoil mechanism being further configured to automatically re-furl the sheet when the lock is released. Furthermore, the first and second frame elements being dimensional and configured to house the roller and sheet when the sheet is fully furled onto the roller.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a top view of a retractable display board made in accordance with the present invention and showing the flexible board in its most extended position.

FIG. 2 is a top view of a retractable display hoard made in accordance with the present invention and showing the flexible board in its most retracted position with the framing elements housing and fully encasing the roller which has the flexible sheet fully furled upon it.

FIG. 3 is a top view of the first framing element.

FIG. 4 is a side view of the first framing element, which is shown in FIG. 3.

FIG. 5 is a lop view of the first framing element which is shown in FIG. 3 showing the apertures and the brackets in place.

FIG. 6 is a side view of the first framing element which is shown in FIG. 5.

FIG. 7 is a top view of the second framing element.

FIG. 8 is a side view of the second framing element which is shown in FIG. 7.

FIG. 9 is a top view of the second framing element which is shown in FIG. 7 showing the apertures and the hook and loop fastener (Velcro™) used to attach the frame element to the display surface.

FIG. 10 is a side view of the second framing element which is shown in FIG. 9.

FIG. 11 is a view of the roller that has a lockable recoil mechanism coupled to it.

FIG. 12 is a top view of the flexible sheet.

FIG. 13 is a side view depicting the flexible sheet which is shown in FIG. 12 being furled upon the roller which is shown in FIG. 11.

FIG. 14 shows the flexible sheet which is shown in FIG. 12 partially furled upon the roller which is shown in FIG. 11.

FIG. 15 shows the flexible sheet shown in FIG. 12 fully furled upon the roller shown in FIG. 11 and attached to the first framing element shown in FIG. 3. Also shown is lock lever which activates or deactivates the locking mechanism.

FIG. 16 shows the flexible sheet of FIG. 12 partially furled upon the roller which is shown in FIG. 11 with the back or underside of the sheet exposed to reveal the hook and loop fastener used to attach the flexible sheet to the second framing element which is shown in FIG. 9,

FIG. 17 in the top view of the display board shown in FIG. 1 with the surface imprinted with the image of a sports playing surface.

FIG. 18 is a side view of the intractable display board shown in FIG. 1 showing the flexible sheet in a fully extended orientation.

FIG. 19 is a side view of the display hoard in an almost fully retracted position.

FIG. 20 is a side view of the display board depicting the second frame element shown in FIG. 9 rotating towards the first frame element shown in FIG. 5

FIG. 21 is a side view of the retractable display board showing the first and second framing elements fined together and in position to completely enclose the roller and flexible sheet.

FIG. 22 is a side view of the retractable display board in the fully retracted position with the framing elements completely encasing the roller and flexible sheet.

In the drawings like characters of reference indicate corresponding parts in the different figures.

### DETAILED DESCRIPTION OF THE INVENTION

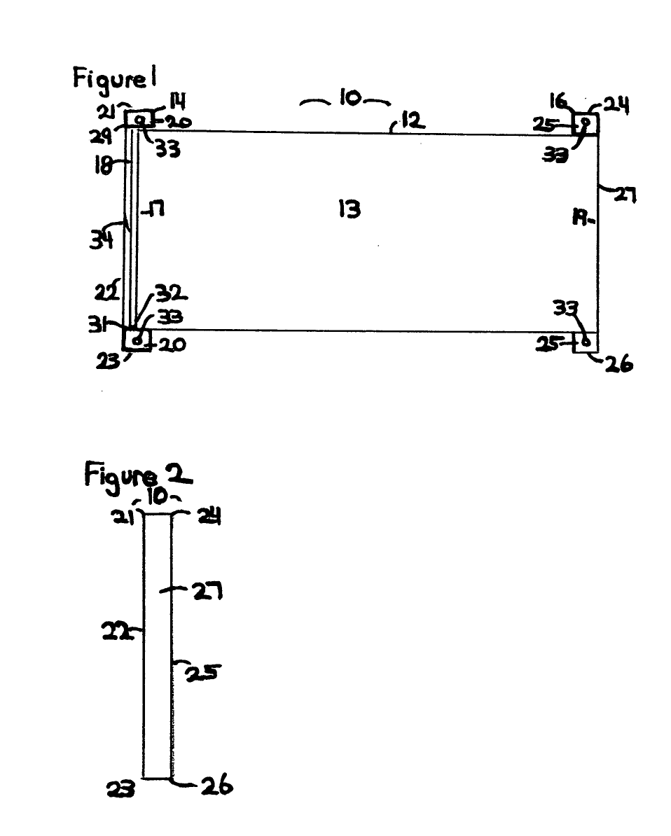

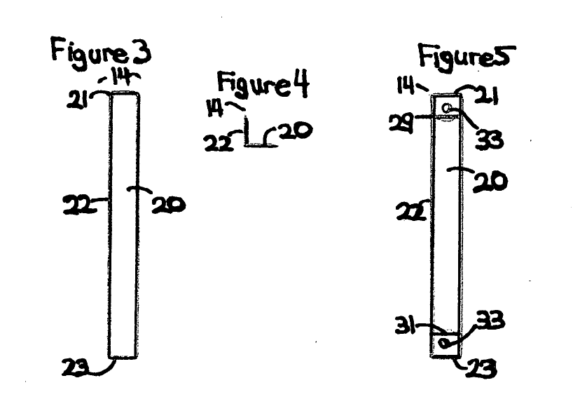

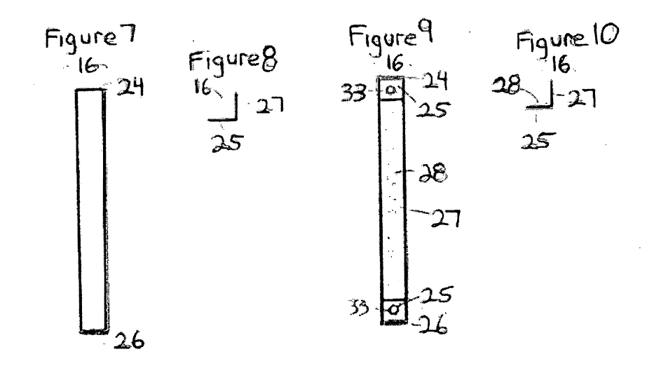

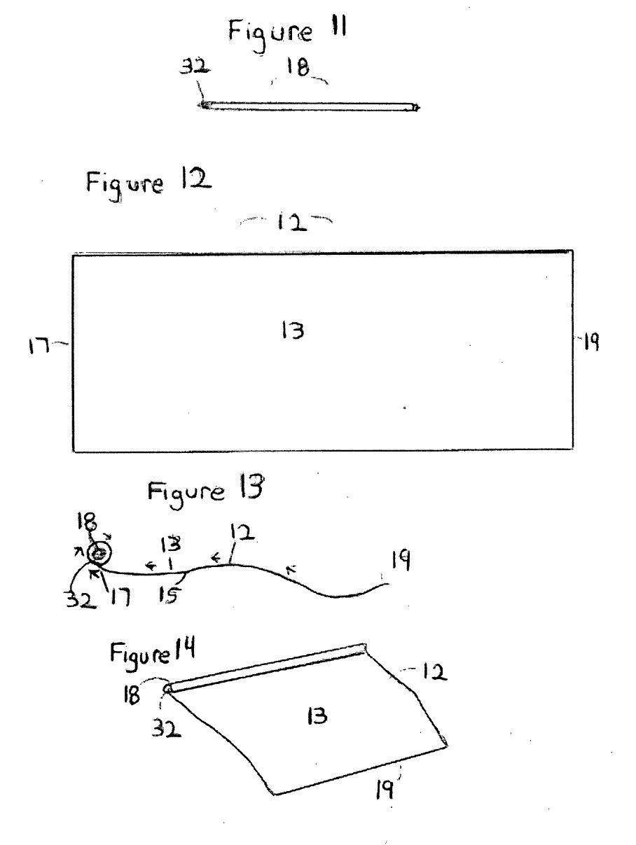

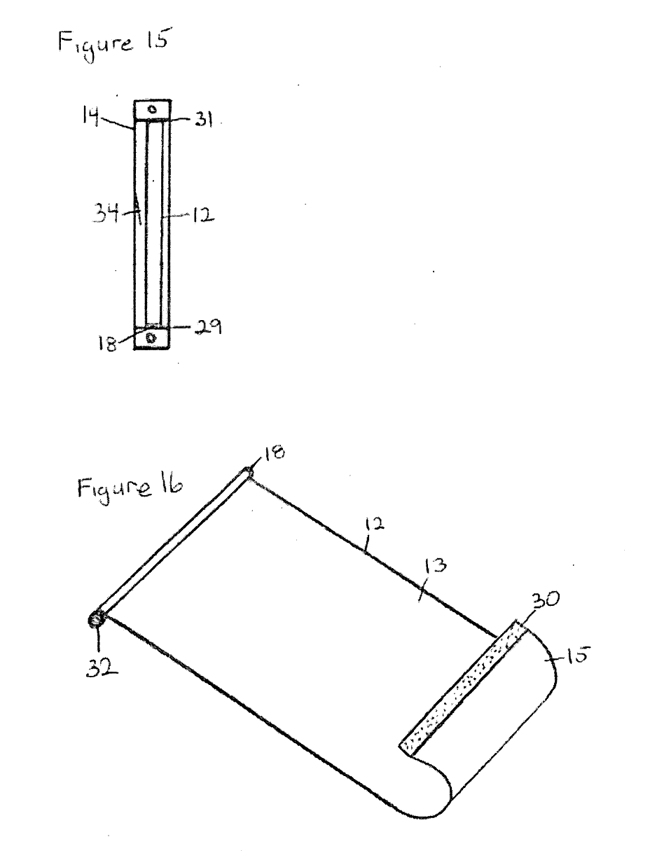

Referring firstly to FIG. 1, a retractable display hoard made in accordance with the present, invention is shown generally as item 10 and consist of flexible sheet 12 mounted to frame elements 14 and 16. Sheet 12 has a front surface 13 and a back surface 15 which are dimensioned and configured to provide an easily viewed surface. Preferably, sheet 12 is made of a flexible sheet of polymer such as vinyl, which may be treated to permit a variety uses. Surface treatments for rendering vinyl sheet compatible for use with dry erase markers, magnets or permanent inks are well known in the art. Sheet 12 could be a dry erase white hoard. Also, sheet 12 may have magnetic or magnetic receptive properties to enable the user to adhere markers and the like to the surface. In addition sheet 12 may be receptive to permanent ink in allowing surfaces 13 and 15 to be imprinted with an image. Sheet 12 may also have a combination of these properties.

Referring to FIG. 2 when the flexible sheet 12 is fully retracted framing elements 14 and 16 form u compact housing that fully encases the roller 18 and flexible sheet 12.

Sheet 12 has opposite ends 17 and 19. End 17 of sheet 12 is attached roller 18 which is connected to frame element 14 along it's length by means known generally in the arts as brackets 29 and 31 which allow the roller to rotate about its long axis. Frame element 14 is preferably an angular member having a “L” shaped profile with walls 20 and 22 at right angle to each other. Walls 20 and 22 are dimensioned to be greater than the diameter of roller 18 with sheet 12 fully furled upon it. Frame element 14 has opposite ends 21 and 23. The length of frame element 14 between ends 21 and 23 is greater than the length of roller 18. Roller 18 is essentially a spring loaded roller as found in spring wound roller blinds. Roller 18 is sufficiently long to span the width of sheet 12. Sheet 12 is furled onto roller 18 such that surface 13 is oriented towards roller 18 so that the surface is protected as if is furled up. Roller 18 is spring loaded and biased to rotate in the direction necessary to roll up sheet 12 such that when the sheet is fully rolled tip. roller 18 is biased to roll up the sheet.

Framing element 16 is an angular member having a “L” shaped profile with walls 25 and 27 at right angle to each other. Walls 25 and 27 are dimensioned to allow roller 18 with sheet 12 fully furled upon it so be fully enclosed within framing elements 14 and 16 when they are brought together to form a protective housing. Frame element 16 has opposite ends 24 and 26. The length of frame element 16 between ends 24 and 26 is greater than the roller 18. Wall 25 of frame element 16 has attached to it a temporary connector 28 such as hook and loop (Velcro™) which allows the flexible sheet 12 to quickly be removed from frame element 16. End 19 of sheet 12 has attached to it along it's width on surface 15 a temporary connector 30 such as hook and loop (Velcro™) which is attached to the corresponding temporary fastener 28 On wall 25 of framing element 16.

Display board 10 includes a recoil mechanism tor automatically roiling up (furling) sheet 12 onto roller 18. Recoil mechanism preferably comprises a torsion spring 32 located inside roller 18 which is wound up as sheet 12 is unfurled from roller 18. When sheet 12 is released, torsion spring 32 will bias the roller 18 to rotate so as to furl sheet 12 onto the roller. The recoil mechanism preferably includes a lock mechanism having lock lever 34. The lock mechanism is operable between a locked state wherein roller 18 is locked in place and cannot rotate and an unlocked state wherein the roller 18 is free to rotate so as to furl or unfurl sheet 12. Engaging lever 34 between a locked position and an unlocked position places the lock mechanism in the locked or unlocked state, respectively. Preferably, lever 34 is spring biased towards its locked position such that it must be physically engaged in order to release the lock mechanism and permit the roller 18 to furl or unfurl sheet 12. The lock mechanism may comprise a simple spring loaded cam lock which locks roller 18 in place by means of a spring loaded cam which physically engages roller 18 with sufficient force to prevent the roller from turning.

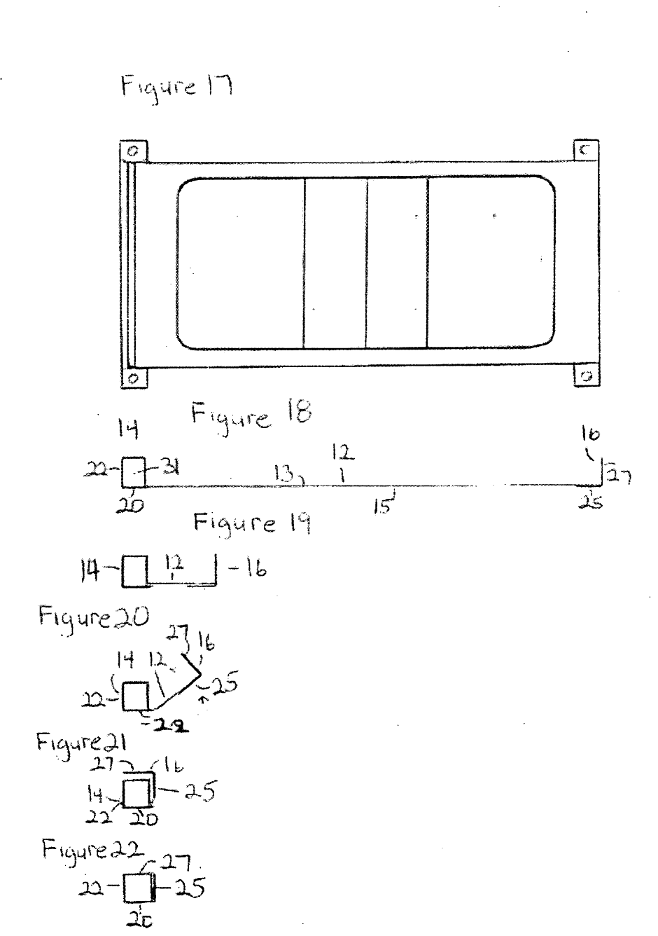

To use writing board 10, lock lever 34 is engaged and frame elements 14 and 16 are moved apart to unfurl sheet 12. When the desired length of sheet 12 is unfurled, lock lever 34 is released causing roller 18 to be locked into place. Frame elements 14 and 16 secure the ends of sheet 12 so that the sheet remains flat. The angular (L shaped) profile of frame elements 14 and 16 prevent the frame elements from warping, ensuring that the sheet 12 remains flat. The user can then use the display board as required. When the user is ready to pack up the display board, lock lever 34 is engaged, releasing roller 18 which is biased to roll up to furl sheet 12 onto the roller 18. Frame elements 14 and 16 are brought together as illustrated in FIGS. 18 through 22. As seen in FIG. 19, it is possible to apply a design, such as a representation of a sport playing field or an other design, onto surfaces 13 and or 15 of the flexible sheet 12.

Also, as better seen in FIG. 1, ends 21 and 23 of frame element 14 and ends 24 and 26 of frame element 16 may be provided with apertures 33 to permit the frame elements to be hung vertically from hooks (not shown) on a wall. To change the flexible surface disconnect the temporary fasteners 28 and 30 which attach the flexible sheet 12 to the second frame element 16 and remove the elongated roller 18, to which the flexible sheet 12 is furled upon, from the brackets 29 and 31 which attach it to the first frame element. To install the replacement surface place roller 18 with the flexible sheet 12 furled upon it into the brackets 29 and 31 of the first framing element 14 and attach the opposite end 19 of the flexible sheet 12 to the second framing element 16 with the temporary fasteners 28 and 30 configured into the flexible sheet 12 and the second framing element 16.

A specific embodiment of the present invention has been disclosed; however, several variations of the disclosed embodiment could be envisioned as within the scope of this invention, it is to be understood that the present invention is not limited to the embodiments described above, but encompasses any and all embodiments within the scope of the following claims.

Therefore, what is claimed is:

1. A retractable display hoard comprising:
a) first and second elongated frame elements each having an L shaped profile with a first and second wall in perpendicular relation to each other;
b) An elongated flexible sheet having a width, opposite first and second ends. The first and second frame elements each, having, a length sufficient to span the width of the flexible sheet.
c) An elongated roller to which the first end of the flexible sheet is attached. The elongated roller is attached to the first framing element between the first and second walls thereof, the elongated roller extending along the length of the first framing element. The elongated roller is dimensioned and configured to permit the flexible sheet to be furled onto the roller.
d) a lockable recoil mechanism coupled to the roller for permitting the roller to unfurl the sited from the roller when the first and second frame elements are pulled apart from one another, the locking recoil mechanism being adapted and configured to hold the sheet in the unfurled position when the mechanism is locked, the recoil mechanism being further adapted to automatically refurl the sheet when the lock is released.
e) the first and second walls of the first and second frame elements being dimensioned and configured to house the roller awl sheet when the sheet fully furled onto the roller.

2. The retractable display board of claim 1 wherein the sheet is attached to the roller such that the top surface of the sheet faces the roller when the sheet is furled onto the roller.

3. The retractable display board of claim 1 wherein the recoil mechanism includes a lever for locking and unlocking the recoil mechanism, the lever movable between a locked position wherein the recoil mechanism is locked and an unlocked position wherein the roller is free to furl the sheet.

4. The retractable display board of claim 3 wherein the lever is biased towards its locked position.

5. The retractable display board of claim 1 wherein the length of the first and second frame elements are greater than the width of the flexible sheet.

6. A retractable display board comprising:
a) first and second elongated frame elements each having opposite ends;
b) an elongated roller attached to the first frame element and extending along the length of the first frame element.
c) an elongated flexible sheet having a width, opposite first and second ends and the first and second frame elements each having a length sufficient to span the width of the sheet; the first end of the flexible sheet being attached to the roller, the roller being dimensioned and configured to permit the sheet to be furled onto the roller; the second end of the flexible sheet being attached to the second frame element
d) a lockable recoil mechanism coupled to the roller for permitting the roller to unfurl the sheet from the roller when the first and second frame elements are pulled apart from one another, the recoil mechanism being adapted and configured to hold the sheet in the unfurled position when the mechanism is locked, the recoil mechanism being further configured to automatically re-furl the sheet when the lock is released, and
e) the first and second frame elements being dimensioned and configured to house the roller and sheet when the sheet is fully furled onto she roller.

7. The retractable display board of claim 6 wherein the first frame element forms a housing partially enclosing the roller, wherein the first frame element is dimensioned and configured to partially enclose the elongated roller along it's length.

8. The device of claim 6 wherein the first and second frame elements form a housing that completely enclose the roller when the display board is in the fully retracted position and the first and second frame elements are brought together.

9. The retractable display board of claim 6 wherein the first and second frame elements each comprise of a first and second wall at right angles to each other.

10. The retractable display hoard of claim 6 wherein the first end of the sheet is attached to an elongated roller wherein the roller in tarn is attached to the first frame element between the first and second walls. The second end of the flexible sheet is attached to the second frame element between the first and second walls.

11. The device of claim 6 whereto the display sheet is adapted and configured to be acceptable for use with dry erase markers

12. The device of claim 6 wherein the display sheet is adapted and configured to have magnetic or magnetic receptive properties.

13. The device of claim 6 wherein the display sheet is adapted and configured to be receptive to permanent ink

14. The device of claim 6 wherein the display sheet is adapted and configured to have a combination of characteristics as described in claims 11, 12 and 13

15. The device of claim 6 wherein the flexible display sheet is attached to the first and second framing elements in a manner which allows the roller and flexible sheet to be easily removed from the first and second framing element
